(19) United States
(12) Patent Application Publication
(10) Pub. No.: US 2020/0030998 A1
(43) Pub. Date: Jan. 30, 2020

(54) FINE TASK FRICTION GRIP ON A MULTI-PURPOSE KNIFE

(71) Applicant: PA Wilderness Skills LLC, Lock Haven, PA (US)

(72) Inventor: Arthur Dawes, III, Lock Haven, PA (US)

(73) Assignee: PA Wilderness Skills LLC, Lock Haven, PA (US)

(21) Appl. No.: 16/522,885

(22) Filed: Jul. 26, 2019

Related U.S. Application Data
(60) Provisional application No. 62/711,742, filed on Jul. 30, 2018.

(51) Int. Cl. B26B 9/00; B26B 3/00

(52) U.S. Cl. CPC B26B 9/00; B26B 3/00

(57) ABSTRACT

The use of etchings into one or more places of a knife in such a way to maximize leverage allows for more precision and safety to be obtained by the holder, when the holder attempts to complete finer tasks with the knife. A knife can be comprised of three portions to the blade: one portion for chopping, one portion for fine tasks, and one portion for chiseling purposes.

### CROSS-REFERENCE TO RELATED APPLICATION

This application claims the benefit of the U.S. Provisional Application Ser. No. 62/711,742 filed Jul. 30, 2018 and herein incorporated by reference.

### BACKGROUND OF INVENTION

Normal outdoorsman knives are ill-equipped for completing finer tasks. When outdoorsman complete these finer tasks, they are often forced to “choke-up” on the knife for leverage, often ending up with the hand on the smooth portion of the blade. This portion provides little friction for optimal grip. Outdoorsman knives are often lacking in all around utility. Most fixed blade knives have merely the dual sharpened blade and the serrated section. These knives require the outdoorsman to carry other tools such as a chisel and a whittling knife for other outdoor purposes.

An etching grip on the blade allows for the knife holder to complete finer tasks due to the implementation of more secure leverage. The etchings in the blade allow for more friction when the holder “chokes-up” (e.g., move grip closer to the blade end) on the knife. The choking-up on the knife adds precision. A normal knife would be smooth where the etchings are, leading to a higher possibility the hand will slip when choking up on the knife. The etchings on the blade add safety and precision when choking-up on the knife.

A multi-purpose knife allows the holder to have an all-in-one outdoorsman knife. An outdoorsman knife comprised of a chopping function, a chisel function, and a fine-task function would provide a single knife to survive outdoors. A chopping section for chopping wood, a fine task section for the more meticulous tasks, and a chisel section for splitting wood all put into one knife is perfect for an outdoorsman.

### SUMMARY OF THE INVENTION

A knife, including but not limited to, a piece of metal sharpened into a blade, a handle fixed to the non-sharpened end of the blade, and an etching on a side of a metal part to a fixed blade for the use of being held to add friction to the user's grip. The knife having a first etching being placed between an end of a handle and a tip of the blade. The knife having the first etching occurring towards the middle of the blade. The knife having a second etching occurring on an opposite side of the blade from the first etching. The knife having an etching being a logo etched into the knife's blade. The knife having the etching being a fingerprint etched into the knife's blade.

A knife, including but not limited to, a handle, a fixed blade, and three or more blade functions on a single piece of metal. The knife having one blade function is a chopping function. The knife having the blade's center of mass occurs closer to the end of the blade on the non-handle side. The knife having one blade function is a fine task function. The knife having one blade function is a chisel function. The knife having a metal piece protrudes from a back of a handle. The knife having a blade for chopping, a blade for fine tasks, and a blade for chiseling.

A knife including, but not limited to, a handle, a single metal piece extending from past a back of the handle to past a front of the handle, a section of the metal sharpened on both sides, a section of the metal sharpened on only one side, an end of the metal being sharpened on one side and being flat, and an etching on the metal piece protruding from the front of the handle.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a photograph of an exemplary tri-purpose knife embodiment.

FIG. 2 is a photograph of an exemplary knife handle.

FIG. 3 is an exemplary illustration of a knife comprising both the friction grip and the three purpose blades.

FIG. 4 is an exemplary diagram of an embodiment of the multi-purpose knife with an etching.

FIG. 5 is an exemplary illustration of an embodiment of the multi-purpose knife with an etching that has a distinctive shape, shown here in the shape of a fingerprint.

FIG. 6 is an exemplary photograph of an embodiment of the multi-purpose knife.

FIG. 7 is an exemplary illustration of an embodiment of the multi-purpose knife with a fingerprint etching.

FIG. 8 is a photograph of an embodiment of the multi-purpose knife with an etching on one side of the blade.

FIG. 9 is a photograph of an embodiment of the multi-purpose knife with dimensions of the blade and handle of the knife.

FIG. 10 is a photograph of an embodiment of the multi-purpose knife with a fingerprint etching.

FIG. 11 is a photograph of the bottom of an embodiment of the multi-purpose knife.

FIG. 12 is a photograph of the top of an embodiment of the multi-purpose knife.

### DETAILED DESCRIPTION OF THE INVENTION

A grip can be the implementation of one or more etchings. The grip can help with precision and safety of the knife holder when completing finer tasks. The etchings can allow the holder to have a better grip on the knife when “choking-up” on the knife. Choking-up can be common for completing finer tasks with a knife, but there can be safety and leverage problems when doing so with regular knives. The etchings can help prevent the fingers from sliding, while also making sure the holder has improved leverage.

An etching can be near the middle of the blade. The blade etching can be for the thumb of the holder and can be sized accordingly. In some embodiments the point of the etching is to make sure a portion of the hand has increased grip (e.g. the thumb does not slide off the blade). Increased grip can be advantageous when completing finer tasks. The etching can be a deep indent for the thumb. The etching can be some design that allows for more friction than the side of a metal blade.

An etching can also be on the opposite side of the blade. The etching can allow another portion of the hand (e.g. the index finger) to have increased friction on the blade as well. In some embodiments, the etching is one section, and in other embodiments the etching wraps around the blade.

In some embodiments, the blade can have more than one type of edge. These embodiments can include a chopping edge, a fine-task edge, and a chisel edge. These features may be contiguous. In some embodiments, the chopping edge is the closest edge to the handle, followed by the fine-task edge leading to the tip of the blade being replaced by the chisel edge.

In some embodiments, the knife has a chopping edge. The chopping edge may be the closest edge to the handle. In some embodiments, the chopping edge can consist of the blade having a gradual gradient on both sides leading to a point. In some embodiments, the chopping edge is accompanied by a metal piece on the handle which can protrude from the handle on the side of the handle where the blade is sharp. The metal piece can be between the index and middle finger placement. The metal piece can enhance the grip of the user when chopping.

In some embodiments, the knife has a fine-task edge. In some embodiments, the fine-task edge is adjacent to the chopping edge. In some embodiments, the fine-task edge is further from the handle than the chopping edge. In some embodiments, the chopping portion of the knife can start at the handle and extend to a point where the blade can go from sharpened on both sides to only sharpened on one side. The fine-task edge may only have a blade gradient on one side of the blade. In some embodiments, the fine-task edge can be accompanied by the fine task friction grip.

In some embodiments, the blade can end in a sharpened flat end for chiseling. In this same embodiment the knife can include the metal of the blade protruding past the back of the handle to be used as a point to bang, a mallet or other hammer-type object, against when the chisel feature is being used.

In some embodiments, the blade can be specifically made to reinforce precision and balance. In some embodiments, the balance can be towards a top-blade heavy balance to help with the chopping function of the knife. The top-blade heavy balance allows for the easier production of force for chopping following naturally from a higher angular momentum created then if the center of mass was in the handle of the blade.

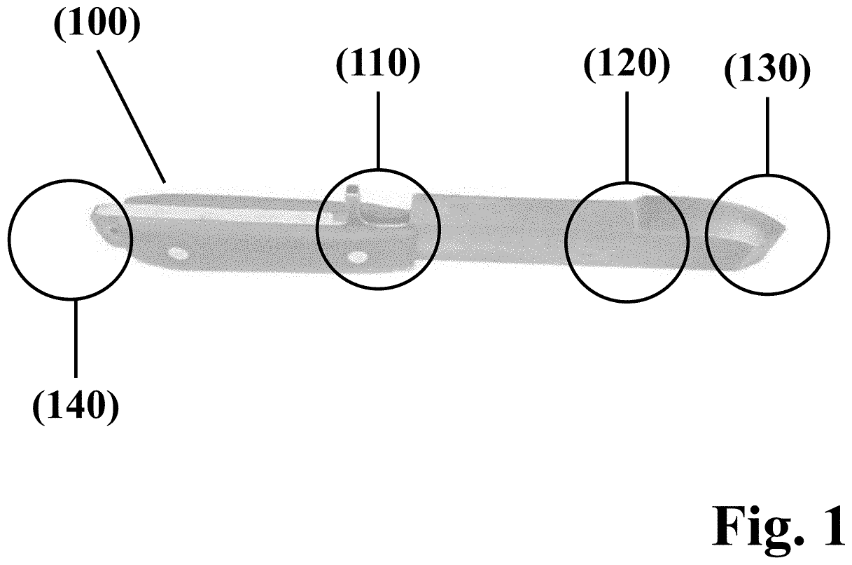

FIG. 1 depicts one embodiment of the multipurpose knife. The knife (100) has a protruding metal piece (110) on the handle to aid in chopping. The point where the blade goes from being sharpened on both sides to only being sharp on one side (120) is the area below where the etching can be in some embodiments. The embodiment also includes a flattened tip (130) and a protruding metal piece in the back of the handle (140) to aid in the chiseling function.

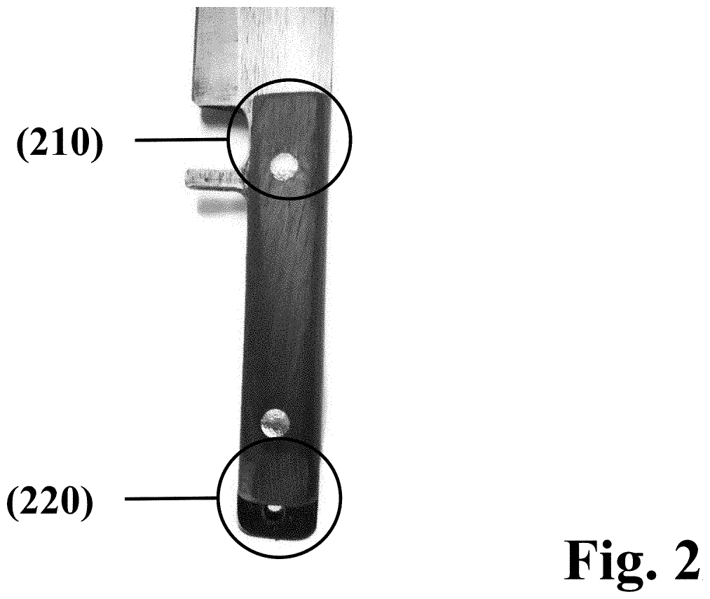

FIG. 2 depicts the handle of the knife in some embodiments. The index finger can be separated from the rest of the fingers in some embodiments through the protrusion of a metal piece on the handle (210). The handle, in some embodiments, can have a metal piece protruding through the back of the handle (220) to be hit when trying to use the chisel function of the knife. In some embodiments the piece can have a hole for being connected to a bag or lanyard.

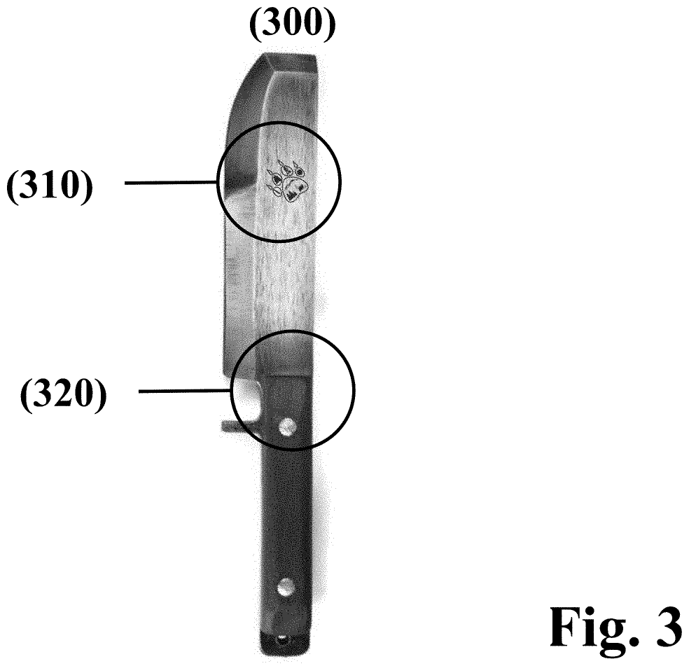

FIG. 3 depicts one embodiment of the knife including the multi-purpose feature and an etching in the shape of a decorative logo. The knife (300) has the flat end for chiseling along with the fine task and chopping features with the change from blocking to fine task feature occurring directly adjacent to the logo etching (310). The embodiment also includes the separation of the index finger from the other fingers on the handle (320) to aid in chopping.

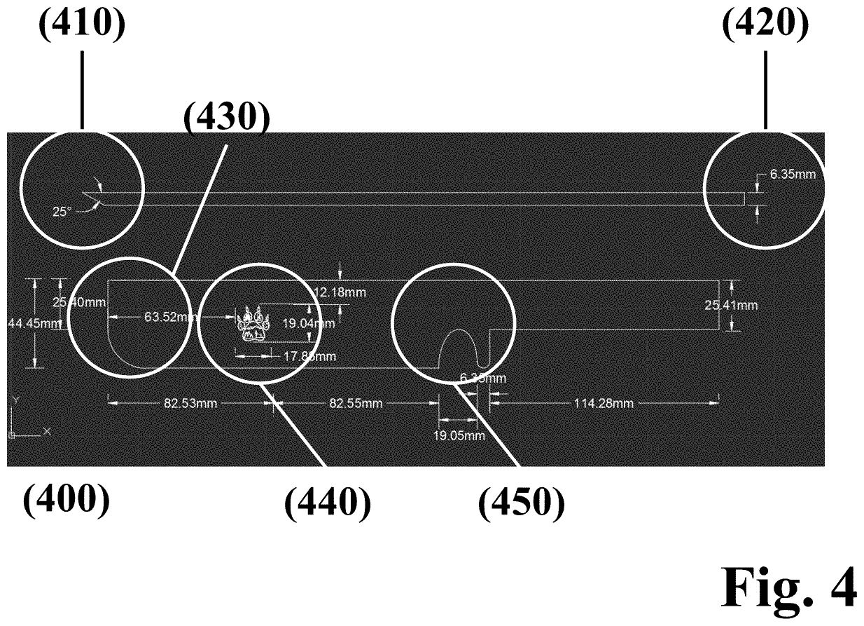

FIG. 4 depicts the dimensions for one embodiment of the outdoorsman knife (400). In this embodiment the chisel end of the blade includes one side being sharpened with a 25 degree gradient (410). In this embodiment, the blade thickness is 6.35 millimeters (420). In this embodiment, the chisel feature (430) can span for 25.40 millimeters, while the blade can be 44.45 millimeters wide. The logo etching (440) in this embodiment can be 63.52 millimeters from the end of the knife and having the dimensions of 19.04 millimeters by 17.88 millimeters. In this embodiment, the knife also includes the index finger slot (450) being 19.05 millimeters wide. One skilled in the art will recognize that the blade measurements can vary in different embodiments.

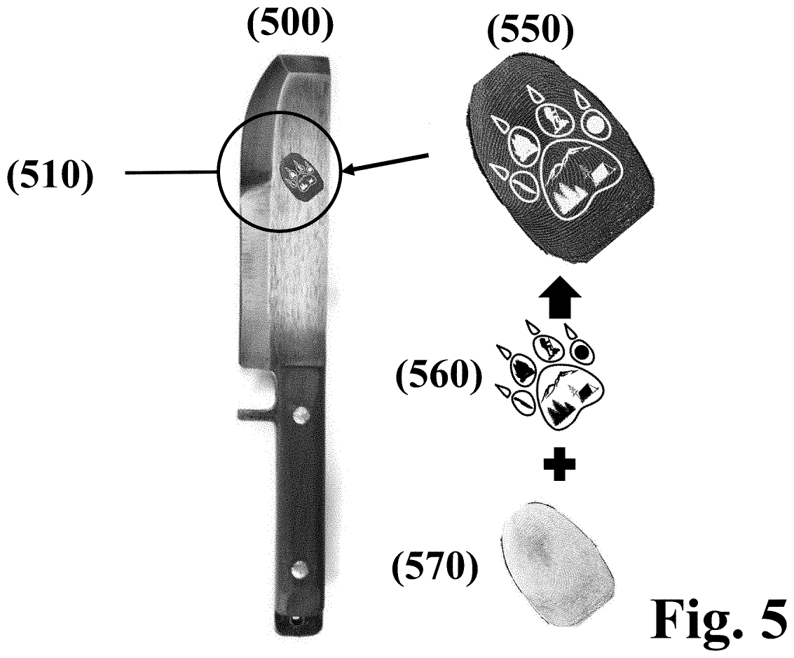

FIG. 5 depicts one embodiment of the multi-purpose knife with an etching grip. This embodiment includes the three-purpose knife (500) with an etching grip (510) on the blade for fine tasks. In this embodiment, the etching (550) is an overlay of a logo etching (560) on top of a fingerprint etching (570).

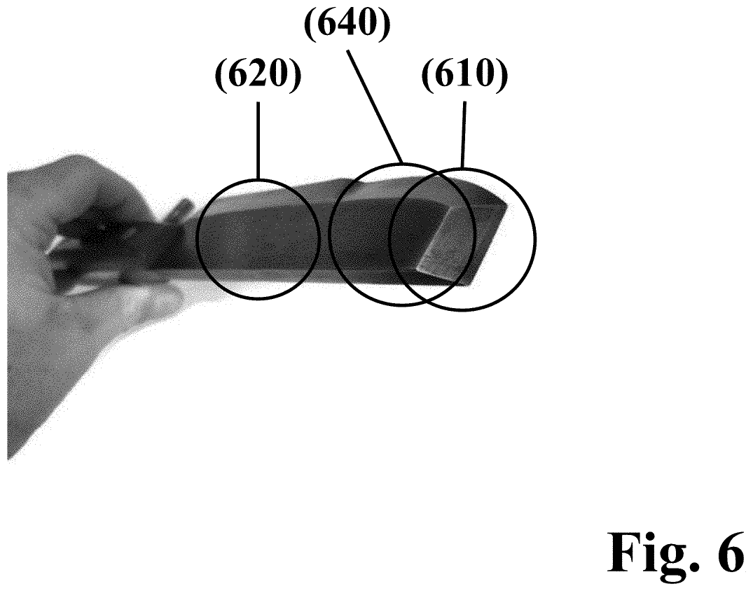

FIG. 6 depicts one embodiment of the multi-purpose knife. In this embodiment, the chisel blade feature (610) is at the end of the blade being followed by the fine task edge (640) with the chopping edge (620) spanning from the end of the fine task edge to the handle. This embodiment contains slight curvature towards a point at the end of the blade before the chisel feature impedes this curvature.

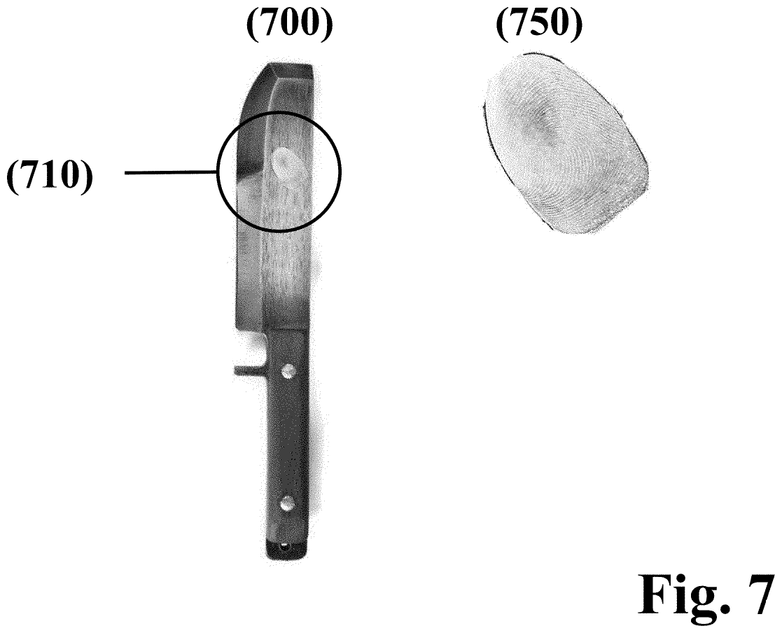

FIG. 7 depicts one embodiment of the multi-purpose knife with a decorative fingerprint etching. In this embodiment, the etching (710) is decorative in the shape of a fingerprint (750). In this embodiment, the knife (700) has the etching adjacent to where the blade goes from sharpened on both sides to only sharpened on one side. In some embodiments, the first etching would be accompanied by another etching on the opposite side for the index finger when completing fine task cutting.

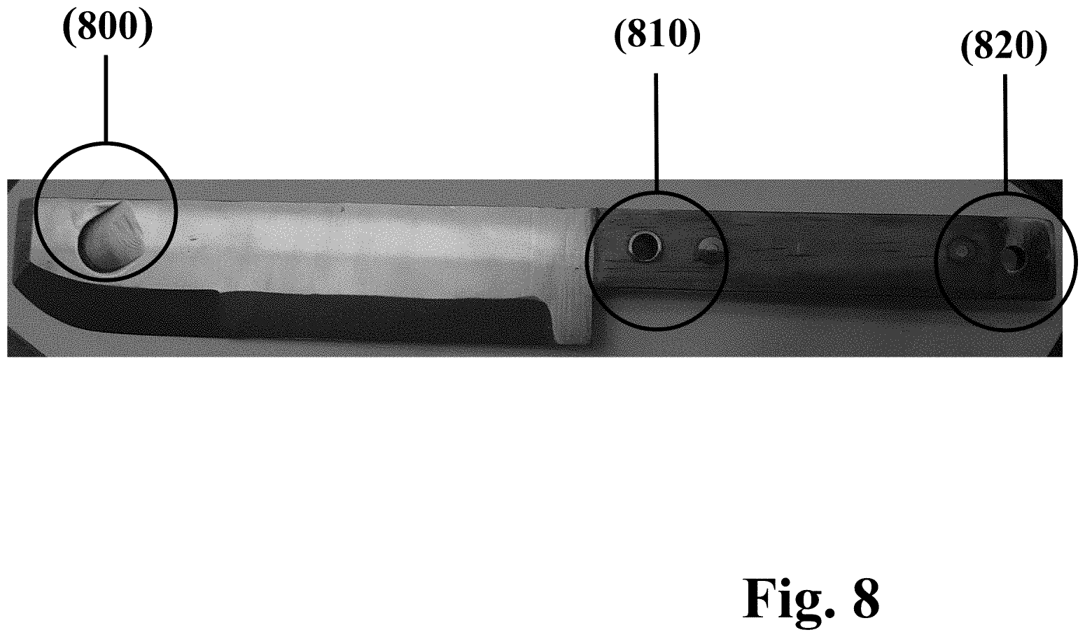

FIG. 8 depicts one embodiment of the multi-purpose knife. In this embodiment, the knife has an etching in the shape of a thumb (800) on the side of the blade near the tip of the knife to add friction to the user's grip. This embodiment of the knife does not have a protruding metal piece on the handle of the knife (810) to separate the index finger from the rest of the fingers like it does in some embodiments. In this embodiment the handle of the knife has a hole at the bottom end of the handle (820) for being connected to a bag or lanyard.

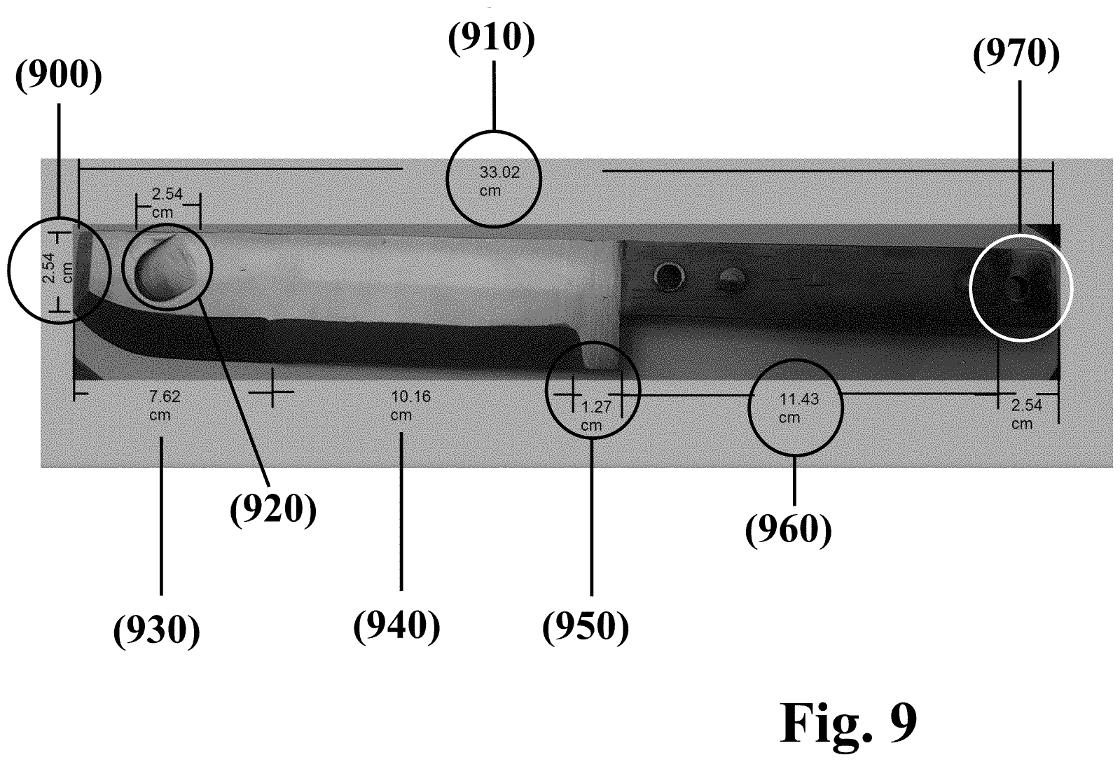

FIG. 9 depicts the dimensions of one embodiment of the multi-purpose knife. In this embodiment, the knife is 2.54 centimeters wide (900), and 33.02 centimeters long (910). The etching in the shape of a thumb (920) near the tip of the blade is 2.54 cm long in this embodiment. In this embodiment, the portion of the blade that is sharp only on one side (930) is 7.62 centimeters long. In this embodiment, the portion of the blade that is sharp on both sides (940) is 10.16 centimeters long. The rear end of the blade in this embodiment contains a small portion (950) that is not sharpened on either side and is 1.27 centimeters long. The handle (960) of the knife in this embodiment is 11.43 centimeters long. The bottom end of the handle containing the lanyard hole (970) is narrower than the rest of the handle. This narrow portion of the handle is 2.54 centimeters long.

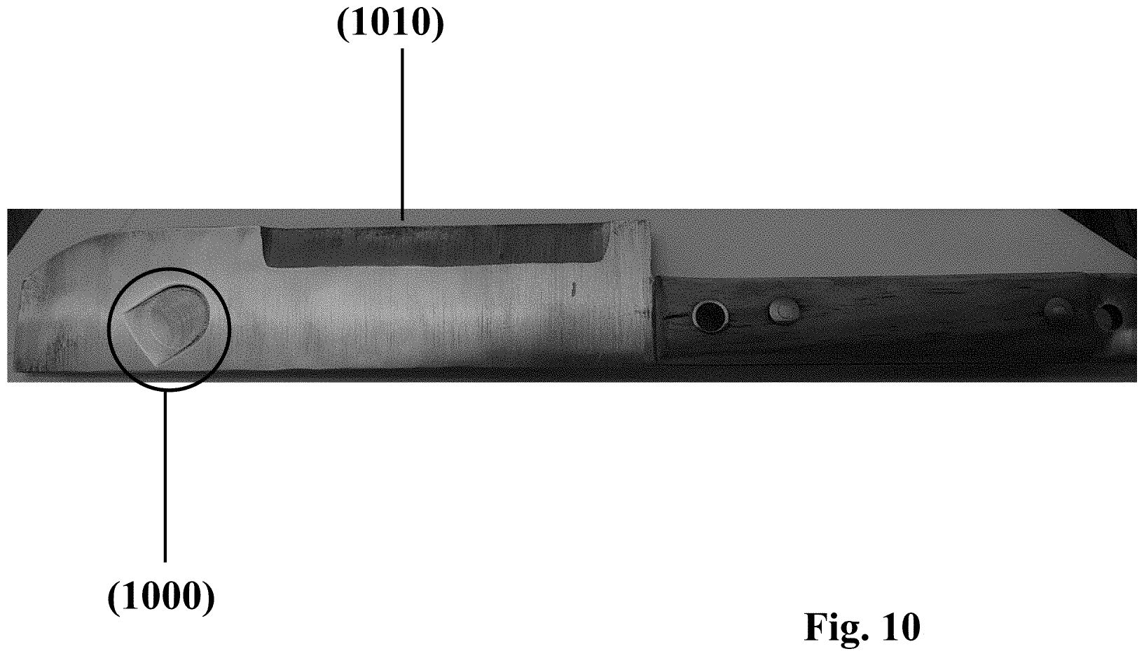

FIG. 10 depicts one side of the multi-purpose knife. In this embodiment, the blade has an etching for the index finger (1000) opposite the thumbprint etching located on the reverse side of the blade. This feature aids the user when completing fine task cutting. In this embodiment, the lower portion of the blade is the portion that is sharp on both sides (1010) and can be used for chopping.

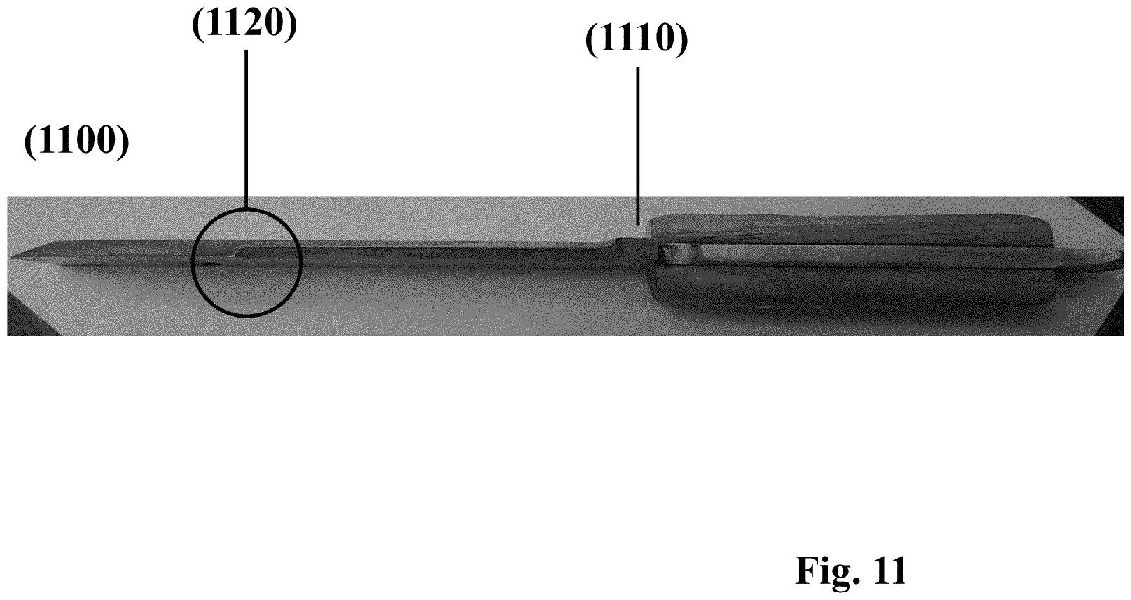

FIG. 11 depicts the underside (1100) of one embodiment of the knife. In this embodiment, the knife has a protruding metal piece on the handle of the knife (1110) to separate the index finger from the rest of the fingers to aid in the chopping function. In this depiction, the part of the knife where the blade goes from being sharp on one side to being sharp on both sides (1120) is clearly visible.

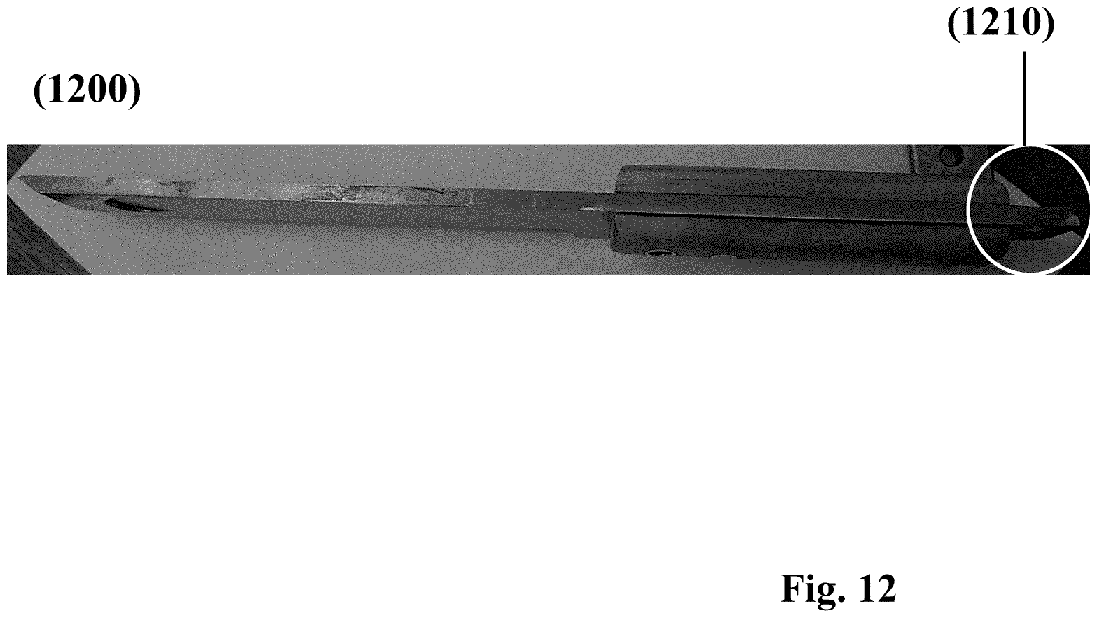

FIG. 12 depicts the portion of the blade that is not sharp and the handle of the knife (1200) when viewed from the top. In this embodiment of the knife, the back of the handle has a protruding metal piece (1210) to aid in the chiseling function.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A knife, comprising:
a piece of metal sharpened into a blade;
a handle fixed to the non-sharpened end of the blade; and
an etching on a side of a metal part to a fixed blade for the use of being held to add friction to the user's grip.

2. A knife as in claim 1, further comprising:
a first etching being placed between an end of a handle and a tip of the blade.

3. A knife as in claim 2, further comprising:
the first etching occurring towards the middle of the blade.

4. A knife as in claim 2, further comprising:
a second etching occurring on an opposite side of the blade from the first etching.

5. A knife as in claim 1, further comprising:
an etching being a logo etched into the knife's blade.

6. A knife as in claim 1, further comprising:
the etching being a fingerprint etched into the knife's blade.

7. A knife, comprising:
a handle;
a fixed blade; and
three or more blade functions on a single piece of metal.

8. A knife as in claim 7, wherein:
one blade function is a chopping function.

9. A knife as in claim 8, wherein:
the blade's center of mass occurs closer to the end of the blade on the non-handle side.

10. A knife as in claim 7, wherein:
one blade function is a fine task function.

11. A knife as in claim 7, wherein:
one blade function is a chisel function.

12. A knife as in claim 11, wherein:
a metal piece protrudes from a back of a handle.

13. A knife as in claim 7, further comprising:
a blade for chopping;
a blade for fine tasks; and
a blade for chiseling.

14. A knife, comprising:
a handle;
a single metal piece extending from past a back of the handle to past a front of the handle;
a section of the metal sharpened on both sides;
a section of the metal sharpened on only one side;
an end of the metal being sharpened on one side and being flat; and
an etching on the metal piece protruding from the front of the handle.
